(19) United States
(12) Patent Application Publication
(10) Pub. No.: US 2003/0185171 A1
(43) Pub. Date: Oct. 2, 2003

(54) Method and apparatus for transmitting diversity or beacon information

(75) Inventors: Aaron Bruce Mullins, Hurst, TX (US); John Stephen Ruppel, Keller, TX (US)

Correspondence Address: POSZ & BETHARDS, PLC, 11250 ROGER BACON DRIVE, SUITE 10, RESTON, VA, 20190, US

(73) Assignee: MOTOROLA, INC.

(21) Appl. No.: 10/108,620

(22) Filed: Mar. 28, 2002

(51) Int. Cl. H04Q 7/00

(52) U.S. Cl. 370/329; 370/503

(57) ABSTRACT

An apparatus and method thereof for selectively transmitting a traffic channel signal or a beacon signal, the apparatus comprising in combination: a base band processor for providing a base band signal that selectively comprises one of traffic information and beacon information; a local oscillator (LO) source for providing a LO signal that is selected from one of a traffic LO signal and a beacon LO signal; a modulator, coupled to the LO signal, for converting the base band signal to a radio frequency (RF) signal; and an amplifier for amplifying the RF signal to provide a transmit signal that selectively corresponds to one of the traffic channel signal and the beacon signal.

### FIELD OF THE INVENTION

This invention relates in general to communication systems, and more specifically to a method and apparatus for transmitting diversity or beacon channels information within such systems.

### BACKGROUND OF THE INVENTION

Communications systems and particularly wireless communications systems have become relatively more complex and have greater system capacities and high operating frequencies. There are many more variations in such systems and more adaptations of those systems to service specialized coverage concerns. Most of these systems, such as cellular or cellular like wireless telephone systems are organized around wide area network principles with fixed transmitters covering relatively large areas or macro cells. Due to the higher operating frequencies and increasing quality of service or coverage concerns, transmit diversity is typically offered for the larger coverage areas or macro cells. Transmit diversity is where a given traffic circuit is supported from two antennas or launch points and two transmitter lineups thereby providing two paths to a subscriber.

Within most systems there will be some areas where providing sufficient coverage is still a problem. One of the adaptations that some service providers have used for these areas which tend to be relatively small, such as the interior of a building, is to set up more or less independent micro cells. Because of their relatively smaller geographic size capacity concerns are not usually significant and path lengths are shorter so transmit diversity is typically not necessary, however, the system does need to know when a subscriber unit approaches or enters one of these areas. Additionally when a subscriber unit approaches the boundary of the service areas for two different service providers the respective systems and subscriber units need to know this to provide more or less continuous or uninterrupted service. One technique used for these situations is to include a beacon transmitter that broadcasts alternative service information on neighbor channels. These have been made available as separate stand-alone units that end up needing to be coupled into an overall system.

What is needed is a method and apparatus that is arranged and adapted to selectively provide or transmit diversity signals or beacon signals thereby eliminating the need for stand alone beacon transmitters and the problems resulting therefrom.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 depicts a simplified diagram suitable for discussing, within a communications system, utilization of a preferred embodiment according to the present invention;

FIG. 2 illustrates a block diagram of a preferred embodiment of an apparatus for selectively transmitting a traffic channel signal or a beacon signal in accordance with the present invention; and

FIG. 3 and FIG. 4 depict a block diagram of a preferred embodiment of a CDMA transmitter that is suitable for use in the FIG. 1 system according to the present invention.

### DETAILED DESCRIPTION OF PREFERRED EMBODIMENT

In overview form the present disclosure concerns communications systems that utilize transmitters to provide service to communications units or more specifically user thereof operating therein. More particularly various inventive concepts and principles embodied in methods and apparatus for transmitting diversity information or signals in wide area cells or beacon information in local area cells or at the boundaries between such systems are discussed and disclosed. The communications systems of particular interest are those being deployed and developed such as GSM, GPRS, EDGE, TETRA, iDEN, CDMA, W-CDMA, CDMA2000, 2.5G, or 3G systems that use modulation formats such as QPSK, DQPSK, OQPSK, BPSK, QAM, and spread spectrum or variations and evolutions thereof that require cost effective high availability transmitters.

As further discussed below various inventive principles and combinations thereof are advantageously employed to provide transmitter line ups that will alternatively perform either the role of a diversity transmitter or a beacon transmitter thus alleviating various problems associated with known systems and techniques while still facilitating cost effective, high performance and high availability service within or hand-off between disparate coverage areas provided these principles or equivalents thereof are utilized.

The instant disclosure is provided to further explain in an enabling fashion the best modes of making and using various embodiments in accordance with the present invention. The disclosure is further offered to enhance an understanding and appreciation for the inventive principles and advantages thereof, rather than to limit in any manner the invention. The invention is defined solely by the appended claims including any amendments made during the pendency of this application and all equivalents of those claims as issued.

It is further understood that the use of relational terms, if any, such as first and second, top and bottom, and the like are used solely to distinguish one from another entity or action without necessarily requiring or implying any actual such relationship or order between such entities or actions. Much of the inventive functionality and many of the inventive principles are best implemented with or in software programs or instructions and integrated circuits (ICs) such as application specific ICs. It is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. Therefore further discussion of such software and ICs, if any, will be limited to the essentials with respect to the principles and concepts of the preferred embodiments, in the interest of brevity and minimization of any risk of obscuring the principles and concepts in accordance with the present invention.

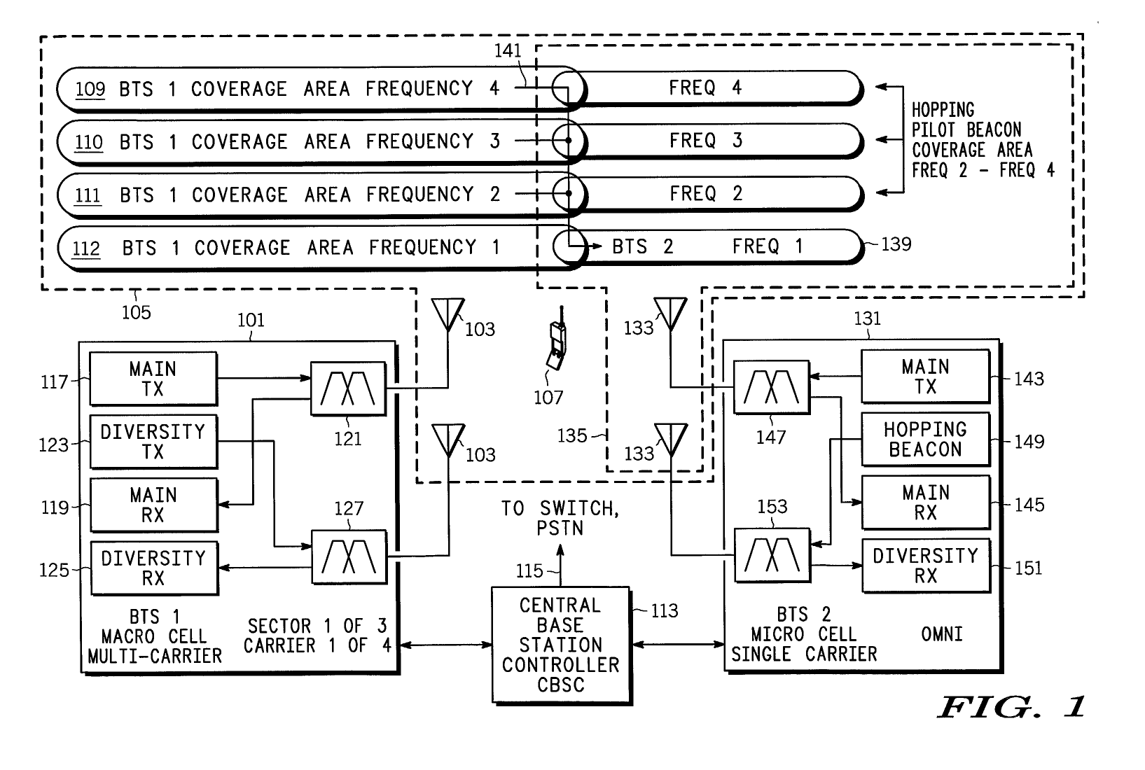

Referring to FIG. 1 a simplified diagram suitable for discussing utilization of a preferred embodiment within a communications system will be described. FIG. 1 shows a multi carrier base station (BTS 1) 101 inter-coupled to an antenna system 103 to provide coverage to users or subscribers or devices 107 (one shown) within a coverage area 105, such as a wide area network (WAN) cell or macro cell or portion thereof, such as one sector of a plurality of sectors. The antenna system 103, depicted, is a multiple (at least two) antenna system suitable for transmitting and receiving diversity signals as well as utilizing multiple carrier frequencies within the coverage area 105. As depicted, BTS 1 uses four carriers 109-112 to provide service to devices within coverage area 105. Devices such as device 107 will be assigned to operate on and will monitor one of the carriers or carrier frequencies 109-112. These assignments of the devices to the different frequencies are typically made according to availability of capacity on the different frequencies and ordinarily a given device will have a more or less equal chance of being assigned to each frequency as this helps load distribution for the system.

Thus the base station will supply or transmit and receive different radio frequency signals with different traffic signals or information on each frequency or carrier. To do so, BTS 1 includes for each carrier and specifically for carrier 1, a main transmitter 117 and a main receiver 119 inter-coupled to a duplexer 121 and thus one of the antennas of antenna system 103 in addition to a diversity transmitter 123 and diversity receiver 125 inter-coupled to a duplexer 127 and then to another antenna of antenna system 103. The particulars of the signals transmitted and received by these transmitters and receivers will depend on the type of system the base station is supporting, such as code division, time division, or frequency division multiple access as well as the underlying diversity strategy for that type of system. This will be discussed in further detail below with reference to a code division multiple access system. In any event the base station is further coupled to a base site controller 113 and thus switch and eventually the Public Switched Telephone System typically via a dedicated link such as a Ti terrestrial link or the like.

FIG. 1 also shows a further base station (BTS 2) 131 inter-coupled to an antenna system 133 to provide coverage to users or subscribers or devices, such as device 107 within a coverage area 135, such as a local area network (LAN) cell or micro cell. The coverage area 135 or micro cell is typically a relatively small area that due, for example, to the vagaries of radio frequency coverage is not provided proper service by BTS 1 101 and antenna system 103. This may be an interior space of a building, for example. As far as the general principles and concepts of the present invention are concerned this may be a local coverage zone where for whatever reason it is preferred to provide service to users within the area via an alternative technology such as a LAN perhaps based on 802.11(a) or (b) or any of a plurality of other well recognized standards. Note that coverage area 135 and 105 may partially or as depicted totally overlap. In any event the antenna system 133, depicted, is a multiple (at least two) antenna system suitable for transmitting and receiving diversity signals typically with an omni directional pattern within the coverage area 135. As depicted, BTS 2 131 uses, in the preferred form one carrier at frequency 1 139 to provide service to devices within coverage area 135. Devices such as device 107 will need to operate on and will monitor frequency 1 139 while they are within coverage area 135 in order to receive service.

In many systems, devices or subscribers such as device 107 while operating on a given carrier such as carrier or frequency 4 109 periodically look for information from neighboring coverage areas in order to facilitate handoffs. In IS-95 CDMA or CDMA 2000 systems, for example, devices monitor the carrier where they are operating a predetermined pilot Walsh code for information regarding neighboring systems and coverage areas. This information is sufficient to facilitate hard handoffs from one coverage area and carrier frequency to another area with another frequency. For example suppose device 107 is operating within coverage area 105 on frequency 4 109 and is presently communicating with another device such as a terrestrial based phone or another portable device on an established connection or circuit and approaches or enters coverage area 135. The device will monitor and once within range pick up the pilot Walsh code which will provide the information such that at the appropriate time based on signal strength or quality or the like, when ordered, the device 107 will undergo a hard handoff, specifically begin operating on frequency 1 at the same time that the circuit is handed off or over to BTS 2 131 on frequency 1 139 thereby maintaining or not dropping the earlier established connection or circuit. In general this is accomplished by having neighboring systems or cells such as here BTS 2 131 transmit beacon signals, preferably hopping beacon signals, on the carrier(s) or frequency(s) that its neighbors operate on. Thus BTS 2 will send a hopping beacon signal on carriers or frequencies 4-2 109-111 that provide the requisite information needed to direct users or devices such as device 107 to the carriers or frequencies that they provide service on or here frequency 1 139 as depicted by arrow 141. The beacon or hopping beacon signal will be transmitted on frequency 4 for a period of time and then move or hop to frequency 3 and so on. Note that when the device moves away from coverage area 135 it will once again see the walsh pilot code from BTS 2 on frequency 1 and therefore a hard hand off is not required and thus a separate beacon signal is not necessary. However in other systems where the micro cell used a different frequency or completely different signal formats such a beacon signal would be required in both directions. Additional information concerning the operation of and specifics of beacon signals for IS-95 CDMA systems will be discussed below.

BTS 2 by virtue of the smaller coverage area 135, will typically forego the use of transmit diversity that is more common in the larger macro cell areas and rely instead only on receive diversity for proper service quality. Thus BTS 2 131 will include a main transmitter 143 and a main receiver 145 for transmitting and receiving traffic channels both inter-coupled to a duplexer 147 and from there to an antenna of the antenna system 133 as well as a beacon transmitter 149, preferably a hopping beacon transmitter, for transmitting beacon signals and a diversity receiver 151 for receiving traffic signals via a diversity channel both inter-coupled to a duplexer 153 and thus another antenna of antenna system 133. By observation, the difference between BTS 1 and BTS 2 at the level depicted is the diversity transmitter 123 for BTS 1 and the Beacon transmitter 149 for BTS 2. Thus with an apparatus or transmitter that can selectively perform either the transmit diversity or beacon transmit function, the stations would have a common architecture thereby increasing volumes for the stations and overcoming problems with prior art solutions that used an add-on beacon transmitter that needed to be interfaced with and integrated into the BTS systems. Since the equipment is now suitable for multiple applications the number of different types of equipment that must be procured and supported will be reduced to the advantage of supplier and network operators alike.

Essentially the base stations above handle the radio links to and from subscriber devices or users of portable or mobile equipment within their respective coverage areas and the land or terrestrial based portions of the systems or networks. Generally the base stations can be thought of as including and inter-coupled a communications and control function, a receiver function, and a transmitter function. Each of these functions can be quite complex in there own right and comprise redundant systems. The receiver and transmitter functions or blocks will inevitably include tens of receivers and transmitters. These stations and antenna systems are generally known and available from multiple suppliers, such as Motorola, etc., and when the transmitters are modified and constructed according to the principles and concepts disclosed herein improved performance and cost advantages can be realized.

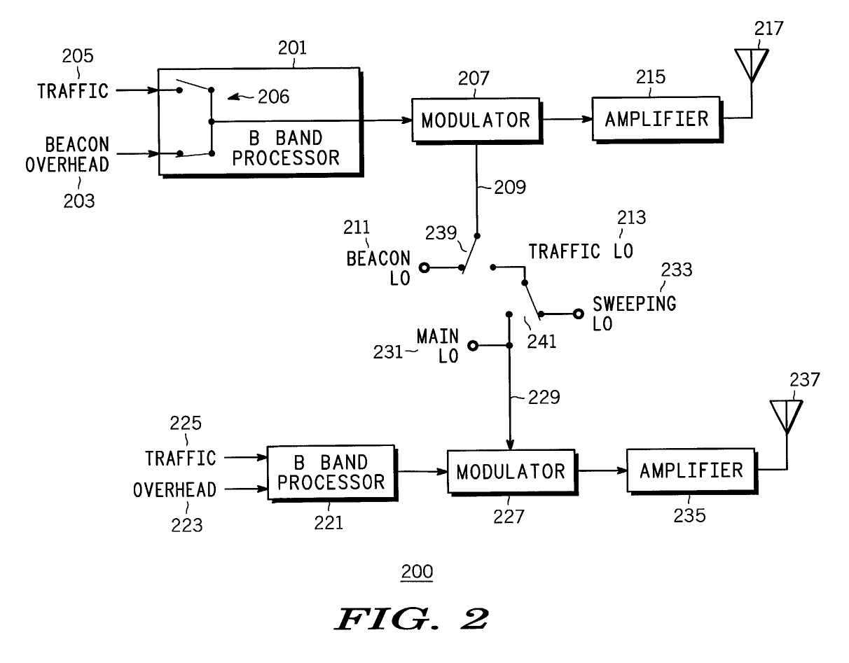

Referring to FIG. 2, a block diagram of a preferred embodiment of an apparatus 200 for selectively transmitting a traffic channel signal or a beacon signal will now be discussed and described. The FIG. 2 apparatus is a portion of a transmitter lineup suitable for use in base stations such as those above described or others in various other systems in the more general case. Generally the selective transmission of a traffic channel signal or a beacon signal is accomplished by selecting the appropriate input information as well as a local oscillator or local oscillator behavior to provide the, respective traffic channel or beacon signals that are presented to the amplifiers, then amplified, and thus transmitted. Note that while a more or less conventional lineup, albeit with inventive modifications, is shown, the principles and concepts herein are equally applicable to a direct digital synthesis (DDS) schema. In a DDS approach, as is known, frequency conversion is a relatively simple numerical procedure, however the underlying hardware and processes must be capable of high speed operation. Thus as integrated circuit technologies evolve it is expected that the preferred approach for implementing the apparatus will evolve to using DDS techniques for frequency conversion including the appropriate local oscillator behaviors.

The apparatus is arranged and constructed for selectively transmitting a traffic channel signal or a beacon signal. The apparatus is essentially an inventive transmitter line-up or portion thereof that includes a base band processor 201 for providing a base band signal that selectively comprises traffic information 205 or beacon information 203. The selective functionality is depicted in a representative fashion by the switches 206 within the base band processor 201 that are intended to signify that the inputs into the base band processor or that the processing undertaken is selectively applied to various inputs depending on the desired base band signal. Generally the base band processor is expected to provide a base band signal that may be digital or analog but preferably analog and is representative of the information that will be used for modulation of a radio frequency signal. Thus the specific functions of the base band processor will be system dependent but may be expected to include combining various traffic or payload signals and overhead information, parsing this information, various error coding and channel coding activities, spreading in the case of CDMA, and so on according to the particular system standards, including air interface standards. For example these base band processing functions can be expected to vary according to whether the system is a code division, time division, or frequency division multiple access system. Given a particular system, such as CDMA with the relevant standards and system architecture one of ordinary skill, in view of the principles and concepts disclosed herein, would be able to implement the base band processor in digital signal processor software or hardware or combination in integrated circuit form. Generally either the base band processor or modulator discussed below will also have one or more digital to analog converters for converting a digital signal to and providing an analog equivalent signal.

The apparatus further includes a modulator 207, coupled to the base band signal and to a local oscillator (LO) signal 209, for converting the base band signal to a radio frequency signal according to the LO signal. The LO signal is provided by a local oscillator (LO) source 211, 213 and is selected from a traffic LO signal or a beacon LO signal. The modulator is generally known and can be as simple as a mixer for converting an analog base band signal to a radio frequency signal using the LO signal, or a dual conversion lineup using multiple mixers and LO signals, or relatively more complex, such as a direct launch in phase and quadrature (IQ) modulator used to convert separate I and Q base band signals, found in many systems directly to a radio frequency signal. The local oscillator is generally known and will provide a LO signal whose frequency may be steered or hopped from one frequency to another in the case that a hopping beacon signal is required or that can be phase swept or caused to have a known frequency offset from another LO signal.

An additional element of the apparatus 200 is the transmitter 215 that is coupled to the radio frequency signal and arranged and constructed for amplifying the radio frequency signal to provide a transmit signal for driving the antenna 217. The transmit signal by virtue of the selection of an input signal to the base band processor 201 and LO signal selectively corresponds to the traffic channel signal or the beacon signal. Of course as is known the transmitter will include various gain and selectivity stages as required for system power and signal characteristics as well as couplers, such as duplexers, between the transmitter power amplifier or output stages and the antenna all as generally known. As is now evident the transmit signal may correspond to a code division, a time division or a frequency division multiple access transmit signal dependent on the base band processing and so on. Generally the transmit signal is expected to be provided for a wide area network or macro cell such as 105 when the traffic information is selected and for and from or for the benefit of a second network, such as a local area network or a network covering a micro or pico-cell when the beacon information is selected. In situations or under circumstances such as discussed with reference to FIG. 1 it may be especially advantageous if the apparatus is a diversity transmitter for providing service in a macro or wide area cell and thus the transmit signal is a diversity channel signal when the traffic information is selected and alternatively a beacon transmitter providing a transmit signal within a smaller or different coverage and neighboring coverage area that is a beacon channel signal for indicating an alternative carrier or frequency or service provider when the beacon information is selected. When such a smaller or adjacent coverage area has one or more neighbors operating on a plurality of carriers it will be advantageous to transmit a beacon channel signal that is a hopping beacon channel signal that hops among a plurality of alternative carriers when the beacon information is selected. As will be discussed in more detail below the transmit signal when it is a diversity transmit signal can vary according to the form of diversity being utilized. For example in IS-95 CDMA systems at least two forms known as orthogonal transmit diversity and phase sweeping transmit diversity have been contemplated.

The apparatus 200 further preferably includes a second transmitter line-up or portion thereof that includes a second base band processor 221, a second LO source 231, a second modulator 227, and a second amplifier 235 all collectively providing a second transmit signal corresponding to a second traffic channel to an antenna 237.

The base band processor is coupled to a traffic signal 225 and overhead signal 223 and provides a base band signal in a manner analogous to the above discussed to the modulator 227. The LO source 231 is dubbed a main LO and provides a LO signal 229 to the modulator for use in converting the base band signal to a radio frequency signal to drive the amplifier 235. In the context of FIG. 1 these elements may be thought of as the main transmitter whereas the previously discussed lineup 201, 207, 215 may be thought of alternatively as the diversity transmitter or beacon transmitter.

In order to accomplish these disparate tasks in addition to proper selection of the inputs for the base band processor a proper LO signal is selected. When the beacon transmitter is desired switch 239 is coupled to a beacon LO 211 that is preferably is a hopping beacon LO or an oscillator that is switched from one frequency to another. When the traffic transmitter or diversity transmitter is desired the switch 239 operates to select the traffic LO 213. The traffic LO 213 is provided through switch 241 as either a sweeping LO 233 (main LO with a constant small frequency offset or continually growing thus sweeping phase offset) when phase sweeping transmit diversity is used or as the main LO 231 when orthogonal transmit diversity is used. These switches may be thought of as a logical depiction as in practice it may be beneficial to provide the main LO and another LO that is either a, preferably, hopping beacon LO or an LO with a constant frequency offset from the main LO.

Given this the second transmit signal from the second amplifier 235 is preferably a first diversity signal or a main signal and the transmit signal from amplifier 215 is a second diversity or simply diversity signal when the apparatus is applied in a macro cell or wide area coverage situation. Alternatively the second transmit signal may be a traffic channel signal and the transmit signal the beacon signal in a micro cell environment. Furthermore although amplifiers 215 and 237 are shown as separate amplifiers it is possible to use an amplifier array, such as an array surrounded by Fourier Transform Matrices to collectively amplify the outputs from the modulators and drive with unique and corresponding signals the antennas 217 and 237.

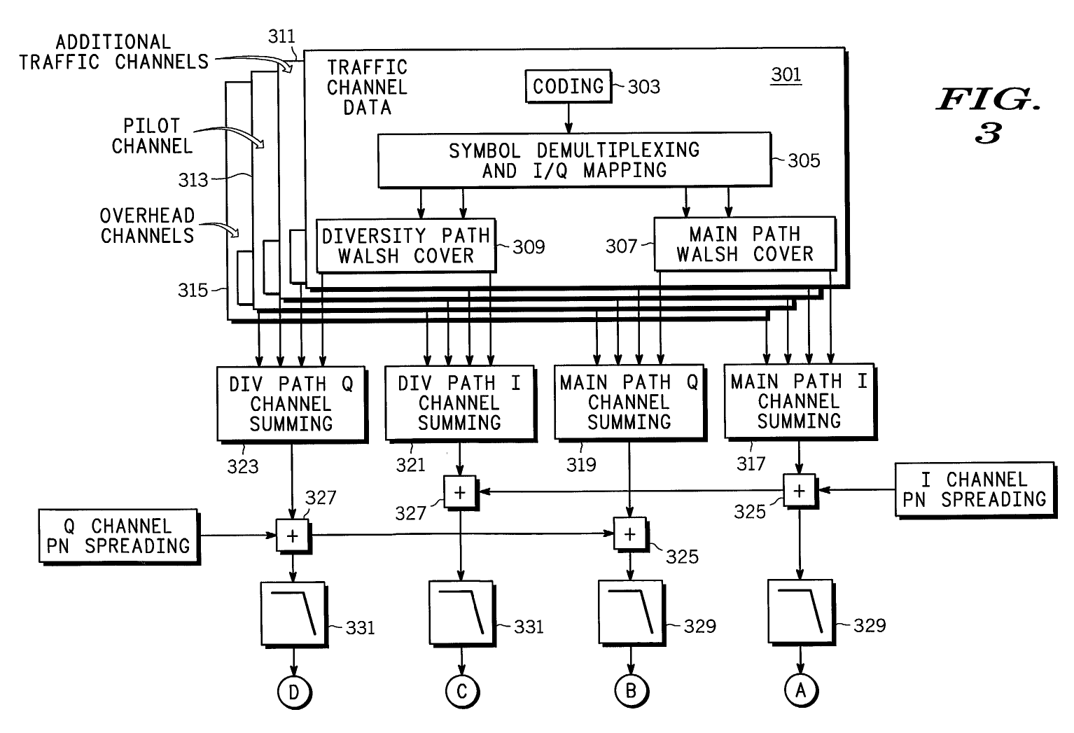

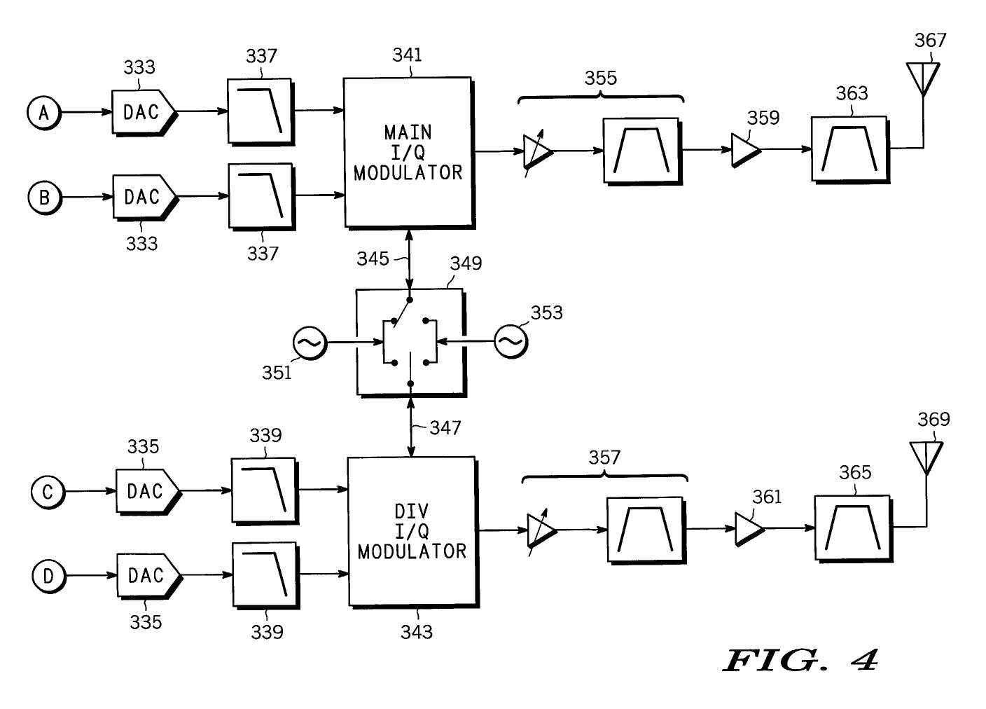

Referring to FIG. 3 and FIG. 4 a block diagram of a preferred embodiment of a CDMA transmitter that is suitable for use in the FIG. 1 system will be discussed and described. The transmitter is arranged and constructed for selectively transmitting a code division multiple access (CDMA) diversity signal or a beacon signal. Some of this discussion will be a review of the description above and some will provide significant detail applicable primarily in a CDMA system. The circles designated A-D in FIG. 3 are coupled to the like circles in FIG. 4. Many of the functional blocks or much of the functionality of the blocks in FIGS. 3 and 4 is implemented in or suitable for implementation in software via a Digital Signal Processor (DSP) or an Application Specific Integrated Circuit (ASIC) or combination thereof or other integrated circuits as appropriate.

Referring to FIG. 3 traffic channel data 301 is first coded in the coding block 303. The coding block is where known functions required for CDMA signals such as convolutional encoding, interleaving, long code generation, power control bit generation, etc. are performed. Following the coding block, is a Symbol De-multiplexing and I/Q Mapping block 305 where the coded traffic channel is “mapped” to the I and Q paths, amplified, and either power split (for phase sweeping or swept transmit diversity (PSTD)) or de-multiplexed (with even bits going to the main path and odd bits going to the diversity path for orthogonal transmit diversity (OTD)) between the main and diversity paths as is known. The I and Q main and diversity paths are then coupled to Walsh cover blocks that apply the appropriate orthogonal or quasi orthogonal cover or spreading to the main and diversity signals again as known. For PSTD diversity, the main and diversity paths use the same cover (Walsh function). This helps existing IS95A/B mobiles to benefit from transmit diversity. For an OTD diversity approach, the cover is different for the main and diversity paths (different Walsh function).

FIG. 3 also shows a block 311 where the same processes as above described have been performed on additional traffic channels plus a block 313 for the Pilot Channel, and a block 315 for Overhead Channels (a more detailed description of these blocks as well as the Traffic Channel blocks described above can be found in section 3 of the TIA/EIA/IS-2000 Layer standard). Note that for OTD diversity, different pilots are provided for the main and diversity paths. For PSTD diversity, the same pilot is provided to the main and diversity paths. Each of the main and diversity I and Q Traffic, Pilot and Overhead channels are then coupled to and summed in the respective channel summers 317, 319, 321, 323 to provide summed output signals as depicted in FIG. 3. Channel summers 321 and 323 are coupled to the pilot and overhead channels but selectively coupled to one or more traffic channels. Specifically when a beacon or hopping beacon transmitter is implemented the traffic channels are not coupled to summers 321 and 323 however the same pilot and overhead channels that are coupled to the main summers are coupled to the channel summers 321, 323.

Following the Channel summing blocks, are the psuedo-random spreaders 325, 327 that apply the known CDMA PN spreading functions for spreading the summed output signals. The PN spreading function (often referred to as the PN short code) is used to identify each coverage area, such as a sector and is the same for main and diversity paths but different for I and Q paths as depicted. Following the PN spreading function are base band filters 329, 331 used to shape the base band channels. At this point, the signals leave FIG. 3 and go to FIG. 4 where they are coupled to digital to analog converters (DACs) 333, 335 where the summed output signals as spread and filtered are converted to analog signals. Following the DACs in FIG. 4 are analog filters 337, 339 used to filter the output of the DACs (remove aliasing and improve analog Signal to Noise).

Following the analog filters, the signal proceeds to modulators 341, 343, preferably vector I/Q modulators. The modulators convert the analog signals to radio frequency (RF) signals according, respectively, to LO signal 345, 347. The implementation shown in this block diagram uses direct launch I/Q modulators supplied a LO source 349 that is a switch that couples a Primary or main LO signal or source 351 to the main I/Q modulator 341 or one of a diversity LO or Beacon LO source 351 or 353 to the diversity or beacon modulator 343. For an OTD type transmit diversity approach, the Primary LO source 351 is routed to both the main I/Q and diversity I/Q modulators by appropriate switching in the switch module. For a PSTD type transmit diversity approach, the Primary LO is coupled to the Main I/Q modulator 341 and the Beacon LO operating as a diversity LO by virtue of being phase swept at a low rate (corresponding to a small frequency offset) is coupled to the diversity I/Q modulator. For either of the transmit diversity approaches, the Hopping Beacon capability of the “Div or Hopping Beacon LO Injection” source is not used. However when a beacon transmitter is implemented the beacon LO 353, preferably a hopping beacon LO, is coupled to the diversity modulator 343. Following the I/Q modulators, the RF signals proceed to the Low Level RF Amplification blocks 355, 357 typically consisting of fixed and/or variable gain blocks and RF filtering. After low level amplification and filtering is completed, the signals are coupled to amplifiers 359, 361 for amplifying the RF signals to a high signal level (typically 20 to 40 watts per traffic carrier or signal and 1-2 watts per beacon signal as adjusted at the low level amplifier stage 357 for example) to provide transmit signals. The transmit signal from amplifier 361, depending on the earlier selections, corresponds to the CDMA diversity signal or the beacon signal. The final stage before leaving the base station is additional RF filtering at filters 363, 365 after which the transmit signals are coupled to antennas 367, 369 typically through duplexers (not shown).

The discussions and descriptions above have shown an LO source for providing a hopping beacon LO signal suitable for generating a hopping RF signal that the amplifier amplifies to provide the transmit signal corresponding to the beacon signal that will be indicative of a plurality of alternative carriers or one carrier per hop or frequency generated. We have discussed a channel summer 321, 323 that is coupled to a diversity traffic channel from 305 as spread by 309 to provide a diversity output signal that the DAC 335 converts to a diversity analog signal; the LO source 349 providing an LO signal corresponding to a diversity LO signal 351, 353 as swept depending on the form of diversity utilized; a modulator 343 that converts the diversity analog signal to a diversity RF signal which the transmitter amplifies to provide the transmit signal corresponding to the CDMA diversity signal. Two forms of transmit signals representing two diversity approaches have been generally discussed with one being an orthogonal transmit diversity signal and the other is a phase swept transmit diversity signal that requires a diversity LO signal that is a phase swept LO signal.

The above discussion has described a LO source that provides a primary or main LO signal; where the transmitter further includes a second modulator 341 for converting a second analog signal corresponding to a main traffic channel to a main RF signal according to the primary LO signal; and an amplifier 359 for amplifying the main RF signal to provide a second transmit signal corresponding to a main traffic signal. While the description of FIGS. 3 and 4 was in the context of a CDMA system it should be clear that the principles and concepts apart from the low level base band processing would be appropriate for providing a transmit signal from amplifier 359 that is frequency hopped, a code division, a time division, and a frequency division multiple access traffic signal and wherein the transmit signal from amplifier 361 corresponds to a beacon signal that may be hopped depending on the surrounding neighbors frequency usage. Of course the transmit signals from the amplifiers may be a first or main CDMA orthogonal transmit diversity signal and a second CDMA orthogonal transmit diversity signal. Alternatively the transmit signals from amplifiers 359, 361 may be, respectively, a first or main CDMA transmit diversity signal and a second CDMA diversity signal that is further a CDMA phase swept transmit diversity signal.

Hopping Beacons are used in CDMA systems (IS95A/B/C, CDMA2000, etc. but not UMTS) to assist hard hand offs (hand offs from one frequency to another frequency). A typical application might be when a subscriber moves from a multi-carrier macro cell system to an indoor single carrier micro or pico cell system. The micro or pico cell system includes a Hopping Beacon to assist the hard handoff required to enter the indoor cell system. The following briefly describes how a hard hand off occurs using a hopping beacon.

(1) As a mobile in an active call approaches the cell using a Hopping Beacon, the pilot transmitted by the Pilot Beacon becomes stronger than a first threshold programmed into the subscriber device.

(2) The mobile transmits a Pilot Strength Measurement Message (PSMM) to the base station serving the mobiles current cell.

(3) The BSC (Base Station Controller) responds to the mobile denying handoff to the beacon.

(4) When the Pilot Beacon pilot strength at the mobile exceeds a second threshold, the mobile generates another PSMM.

(5) The CBSC then directs the mobile to hard handoff to the cell using the Hopping Beacon and routes the ongoing circuit through that cell or base station serving that cell.

In IS-95 CDMA systems the Hopping Beacons frequency and the micro cells frequency must have the same PN offset within a coverage area such as a sector (PN offset is used in a CDMA system to determine the area identity). Different PN offsets would cause the mobile to lose CDMA system synch. The Hopping Pilot Beacon's PN offset must be in the subscriber's neighbor list. The Hopping Beacon can hop between a number of frequencies with 3 working well and 6 being a near maximum. The Hopping Beacon transmits on each frequency for a period of time called the Dwell time, for example, between 0.72 and 1.04 seconds. The time between each Dwell time is called the Gap. The Gap is the minimum amount of time for the Hopping Pilot Beacon's synthesizer to change from one frequency to the next and this is 0.16 seconds or more. The Cycle length is the time to for the Hopping Pilot Beacon to complete the frequency list. A typical time for this list with three frequencies is approximately 2.24 seconds.

Several transmit diversity schemes have been proposed for use in IS95A/B/C and CDMA2000 systems. Two of these are Orthogonal Transmit Diversity (OTD) and Phase Sweeping Transmit Diversity (PSTD). For OTD, coded bits (data) are split (de-multiplexed) between two transmit paths (antennas). Data on each transmit path is spread using separate Walsh codes. The data on each transmit path is orthogonal to the data from the other transmit path (due to the separate Walsh codes). In theory, since the two paths are orthogonal, they will have minimum interference to each other when arriving at the subscriber in a non-fading environment. In a fading environment, assuming that the two paths are relatively independent, a diversity gain will be realized. For PSTD, coded bits (data) is power split between two transmit paths (antennas). An artificial Doppler or frequency shift is introduced to one of the transmit paths. This has been shown to reduce the time duration of fading at low mobile velocity. The Doppler shift is introduced by phase sweeping one of the transmit paths at a low rate (equivalent to a small frequency offset). The advantage to PSTD is that it can be used for existing IS95A/B mobiles. This is because both the main and diversity paths use the same Walsh function for cover. Common to each of the transmit diversity schemes are two, main and diversity, forward link branches (antennas) for each sector in the base station. The two forward link radio branches in the base station provide a diversity path on the down (forward) link from the BTS to the subscriber device.

As a summary and in the context of the methodology that we have discussed with reference to the apparatus figures the following description of a preferred method is provided. We have discussed and described a method of selectively transmitting, preferably using an inventive and common architecture, a traffic channel signal, such as preferably a diversity channel signal, or alternatively a beacon signal. The method includes providing a base band signal that selectively comprises one of traffic information and beacon information and generating or providing a LO signal, where the LO signal is selected from one of a traffic LO signal and a beacon LO signal. Then the process converts the base band signal to a radio frequency signal and amplifies the radio frequency signal to provide a transmit signal that selectively corresponds to one of the traffic channel signal and the beacon signal.

The method is applicable in one aspect where the transmit signal is provided for a wide area network when the traffic information is selected and for a second network when the beacon information is selected. The transmit signal is further, preferably, a diversity channel signal, such as an orthogonal transmit diversity signal or a phase sweeping transmit diversity signal when the traffic information is selected and a beacon channel signal for indicating an alternative carrier when the beacon information is selected. The beacon signal may be a hopping beacon channel signal that hops among a plurality of alternative carriers when the beacon information is selected and circumstances so dictate.

The method of selectively transmitting a traffic channel signal or a beacon signal may further include providing a second transmit signal corresponding to a second traffic channel, for example, where the second transmit signal is a first or main diversity signal and the transmit signal is a second diversity signal. Alternatively the second transmit signal can be the traffic channel signal and the transmit signal will be the beacon signal.

The methods and apparatus, discussed above, and the inventive principles and concepts thereof are intended to and will alleviate problems caused by prior art transmitters for diversity signals and beacon signals. Using the principles of developing by alternatively utilizing a common architecture, a transmit signal that is either a traffic channel signal or a beacon channel signal, is expected to improve equipment procurement, deployment, and support costs and complexities.

Various embodiments of method and apparatus for selectively providing and transmitting a traffic or beacon signal so as to facilitate coverage and handoff processes in either WAN areas or LAN areas have been discussed and described. It is expected that these embodiments or others in accordance with the present invention will have application to many wide area and local area networks. Using the inventive principles and concepts disclosed herein advantageously allows or provides for lower cost more flexibly configurable transmitters that will be required for current and future communications systems and this will be beneficial to both users and providers of such systems.

This disclosure is intended to explain how to fashion and use various embodiments in accordance with the invention rather than to limit the true, intended, and fair scope and spirit thereof. The invention is defined solely by the appended claims, as may be amended during the pendency of this application for patent, and all equivalents thereof.

What is claimed is:

1. An apparatus for selectively transmitting a traffic channel signal or a beacon signal, the apparatus comprising in combination:
a base band processor for providing a base band signal that selectively comprises one of traffic information and beacon information;
a local oscillator (LO) source for providing a LO signal, said LO signal selected from one of a traffic LO signal and a beacon LO signal;
a modulator, coupled to said LO signal, for converting said base band signal to a radio frequency signal; and
an amplifier for amplifying said radio frequency signal to provide a transmit signal that selectively corresponds to one of the traffic channel signal and the beacon signal.

2. The apparatus for selectively transmitting a traffic channel signal or a beacon signal of claim 1 wherein said transmit signal further corresponds to one of a code division, a time division and a frequency division multiple access transmit signal.

3. The apparatus for selectively transmitting a traffic channel signal or a beacon signal of claim 1 wherein said transmit signal is provided for a wide area network when said traffic information is selected and for a second network when said beacon information is selected.

4. The apparatus for selectively transmitting a traffic channel signal or a beacon signal of claim 3 wherein said second network is a local area network.

5. The apparatus for selectively transmitting a traffic channel signal or a beacon signal of claim 1 wherein said transmit signal is a diversity channel signal when said traffic information is selected and a beacon channel signal for indicating an alternative carrier when said beacon information is selected.

6. The apparatus for selectively transmitting a traffic channel signal or a beacon signal of claim 5 wherein said beacon channel signal is a hopping beacon channel signal that hops among a plurality of alternative carriers when said beacon information is selected.

7. The apparatus for selectively transmitting a traffic channel signal or a beacon signal of claim 5 wherein said diversity channel signal is one of an orthogonal transmit diversity signal and a phase sweeping transmit diversity signal.

8. The apparatus for selectively transmitting a traffic channel signal or a beacon signal of claim 1 further including a second base band processor, a second LO source, a second modulator, and a second amplifier all collectively providing a second transmit signal corresponding to a second traffic channel.

9. The apparatus for selectively transmitting a traffic channel signal or a beacon signal of claim 8 wherein said second transmit signal is a first diversity signal and said transmit signal is a second diversity signal.

10. The apparatus for selectively transmitting a traffic channel signal or a beacon signal of claim 8 wherein said second transmit signal is the traffic channel signal and said transmit signal is the beacon signal.

11. The apparatus for selectively transmitting a traffic channel signal or a beacon signal of claim 8 wherein said amplifier and said second amplifier are a multi-channel amplifier.

12. A transmitter for selectively transmitting a code division multiple access (CDMA) diversity signal or a beacon signal, the apparatus comprising in combination:
a channel summer coupled to a pilot channel and selectively coupled to a traffic channel for providing a summed output signal;
a psuedo-random (pn) spreader for pn spreading said summed output signal;
a digital to analog converter (DAC) for converting said summed output signal to an analog signal;
a local oscillator (LO) source for providing a LO signal, said LO signal selected from one of a diversity LO signal and a beacon LO signal;
a modulator for converting said analog signal to a radio frequency (RF) signal according to said LO signal; and
an amplifier for amplifying said RF signal to provide a transmit signal that selectively corresponds to one of the CDMA diversity signal and the beacon signal.

13. The transmitter of claim 12 wherein said LO source for providing said LO signal further provides a hopping beacon LO signal suitable for generating a hopping RF signal that said amplifier amplifies to provide said transmit signal corresponding to the beacon signal that is indicative of a plurality of alternative carriers.

14. The transmitter of claim 12 wherein said channel summer is coupled to a diversity traffic channel to provide a diversity output signal that said DAC converts to a diversity analog signal; said LO source provides said LO signal corresponding to said diversity LO signal; said modulator converts said diversity analog signal to a diversity RF signal and said transmitter amplifies said diversity RF signal to provide said transmit signal corresponding to the CDMA diversity signal.

15. The transmitter of claim 14 wherein said transmit signal corresponds to an orthogonal transmit diversity signal.

16. The transmitter of claim 14 wherein said transmit signal corresponds to a phase swept transmit diversity signal and said diversity LO signal is a phase swept LO signal.

17. The transmitter of claim 12 wherein said LO source further provides a primary LO signal; said transmitter further including;
a second modulator for converting a second analog signal corresponding to a main traffic channel to a main RF signal according to said primary LO signal; and
an amplifier for amplifying said main RF signal to provide a second transmit signal corresponding to a main traffic signal.

18. The transmitter of claim 17 wherein said second transmit signal is one of a frequency hopped, a code division, a time division, and a frequency division multiple access traffic signal and said transmit signal corresponds to the beacon signal.

19. The transmitter of claim 12 wherein said second transmit signal corresponds to said main traffic signal for a first CDMA orthogonal transmit diversity signal and said transmit signal corresponds to the CDMA diversity signal that is further a second CDMA orthogonal transmit diversity signal.

20. The transmitter of claim 12 wherein said second transmit signal corresponds to said main traffic signal for a first CDMA phase swept transmit diversity signal and said transmit signal corresponds to the CDMA diversity signal that is further a second CDMA phase swept transmit diversity signal.

21. A method of selectively transmitting a traffic channel signal or a beacon signal, the method including the steps of:
providing a base band signal that selectively comprises one of traffic information and beacon information;
generating a LO signal, said LO signal selected from one of a traffic LO signal and a beacon LO signal;
converting said base band signal to a radio frequency signal; and
amplifying said radio frequency signal to provide a transmit signal that selectively corresponds to one of the traffic channel signal and the beacon signal.

22. The method of selectively transmitting a traffic channel signal or a beacon signal of claim 21 wherein said transmit signal is provided for a wide area network when said traffic information is selected and for a second network when said beacon information is selected.

23. The method of selectively transmitting a traffic channel signal or a beacon signal of claim 21 wherein said transmit signal is a diversity channel signal when said traffic information is selected and a beacon channel signal for indicating an alternative carrier when said beacon information is selected.

24. The method of selectively transmitting a traffic channel signal or a beacon signal of claim 23 wherein said beacon channel signal is a hopping beacon channel signal that hops among a plurality of alternative carriers when said beacon information is selected.

25. The method of selectively transmitting a traffic channel signal or a beacon signal of claim 23 wherein said diversity channel signal is one of an orthogonal transmit diversity signal and a phase sweeping transmit diversity signal.

26. The method of selectively transmitting a traffic channel signal or a beacon signal of claim 21 farther including providing a second transmit signal corresponding to a second traffic channel.

27. The method of selectively transmitting a traffic channel signal or a beacon signal of claim 26 wherein said second transmit signal is a first diversity signal and said transmit signal is a second diversity signal.

28. The method of selectively transmitting a traffic channel signal or a beacon signal of claim 26 wherein said second transmit signal is the traffic channel signal and said transmit signal is the beacon signal.
